(19) United States
(12) Patent Application Publication
(10) Pub. No.: US 2002/0143913 A1
(43) Pub. Date: Oct. 3, 2002

(54) Network node configuration

(76) Inventors: Ravi L. Sahita, Hillsboro, OR (US); David M. Durham, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/823,185

(22) Filed: Mar. 29, 2001

(51) Int. Cl. G06F 15/173

(52) U.S. Cl. 709/223

(57) ABSTRACT

A managed node includes a first database having metadata descriptive of data stored in a second database. A first process is in communication with that second database. A second process, in local communication with the first process through an interface for interprocess communication, provides communication over a network through a selected protocol. This second process accesses the first database to translate communications between the selected protocol and the selected interface.

This invention relates to the configuration of a network node.

### BACKGROUND

A managed network typically includes several managed nodes that are under the centralized control of a management station. Each managed node maintains configuration data that describes how that managed node is to operate. As part of its management function, the management station may need to modify this configuration data. This requires that the managed node and the management station establish communication. A suitable protocol for establishing communication between a management station and its managed nodes is SNMP (Simple Network Management Protocol).

With SNMP as the communication protocol, each managed node maintains its configuration data locally in a management information base (“MIB”). Because the management node and the management station must communicate across a network, the management station cannot directly access the MIB of a managed node. Instead, the management station sends a message to an SNMP agent executing on the managed node. The SNMP agent then operates on the MIB in response to instructions contained in that message.

To modify configuration data, a network administrator at the management station identifies the objects in the MIB that are to change. The administrator then sends SNMP “set” requests to individually change those objects.

### BRIEF DESCRIPTION OF THE FIGURES

FIG. 1 shows a managed network;

FIG. 2 shows a managed node; and

FIGS. 3 and 4 are flowcharts.

### DETAILED DESCRIPTION

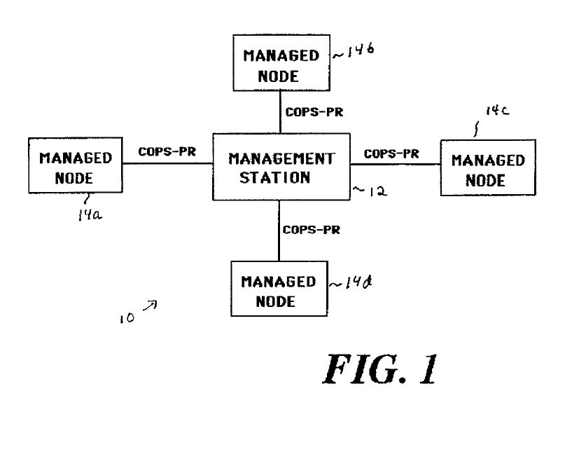

FIG. 1 shows a managed network 10 in which a management station 12 communicates with several managed nodes 14a-d using the common open policy protocol (COPS), and in particular, using an extension of that protocol, COPS-PR, that is specifically adapted for policy provisioning. Each managed node 14a-d thus functions as a policy enforcement point (“PEP”) and the management station 12 functions as a policy decision point (“PDP”). The managed nodes 14a-c can be routers, bridges, hosts, printers, and similar devices.

The use of COPS-PR to communicate management data between managed nodes 14a-d and a management station 12 enables a network administrator to specify a desired configuration at a more abstract level than that which can be specified with SNMP. In effect, COPS-PR acts as a compiler that translates the more abstract description of a desired configuration into the elementary operations supported by SNMP for operating on the MIB.

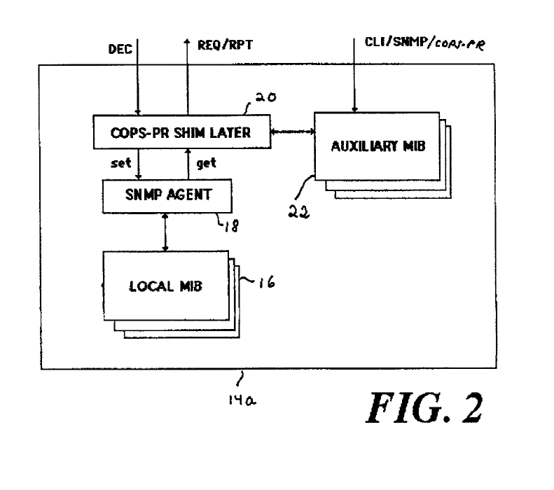

FIG. 2 shows a representative managed node 14a in more detail. The managed node maintains a local MIB 16 that contains configuration data as well as various operating statistics. An SNMP agent 18 in communication with the local MIB 16 modifies or retrieves objects in the local MIB 16 in response to received instructions. As indicated by the arrows in FIG. 2, when the SNMP agent 18 receives a “set” instruction, it modifies an object in the local MIB 16. When the SNMP agent 18 receives a “get” instruction, it retrieves an object from the local MIB 16.

In a conventional network, the SNMP agent 18 receives “get” and “set” instructions from SNMP messages sent by the management station 12. However, in the managed network of FIG. 1, the management station 12 emulates a COPS PDP by sending COPS-PR messages to managed nodes. These COPS-PR messages include attached objects that specify the desired changes in the configuration. The COPS-PR messages are not understood by the SNMP agent 18. As a result, it is necessary to provide a translator that converts a COPS-PR message into a form understood by the SNMP agent.

A COPS-PR shim layer 20 executing on the managed node 14a provides this translation function. The shim layer is configured to emulate a COPS PEP by receiving COPS-PR messages from the management station 12 and providing a corresponding sequence of calls to the API (application program interface) of the SNMP agent 18. The shim layer 20 is also configured to receive data extracted from the local MIB 16 by the SNMP agent 18 and to repackage that data into a corresponding COPS-PR messages for sending to the management station 12.

Because local MIBs vary from one managed node to the next, the shim layer 20 does not know precisely which objects in the local MIB 16 are to be accessed or modified in response to a COPS-PR message from the management station 12. For this reason, the shim layer 20 maintains communication with an auxiliary MIB 22 that stores metadata descriptive of data stored in the local MIB 16.

The metadata stored in the auxiliary MIB 22 includes a specification of data from the local MIB 16 that is to be supplied to the management station in response to a COPS-PR “REQ” or “RPT” message and a specification of data from the local MIB 16 that is expected from the management station upon receiving a COPS-PR “DEC” message. The auxiliary MIB 22 thus functions as a dictionary available for reference by the shim layer 20.

As an example, a managed node 14a can be a router in which the local MIB 16 includes statistics on the number of broadcast packets that have passed through the router. These statistics are identified by an object identifier (“OID”) within the local MIB 16. Periodically, the management station 12 may request reports from that managed node 14a, Such a report would include a large number of statistics in addition to the particular statistic described above.

In collecting statistics from the managed node 14a, it is more efficient to issue a single request for a report rather than to issue a sequence of requests for each individual statistic within the report. To accomplish this, the auxiliary MIB 22 includes all OIDs that identify statistics to be retrieved when the management station 12 requests a report. Upon receiving a COPS-PR communication requesting a report, the shim layer 20 searches the auxiliary MIB 22 for all OIDs associated with a request of that type. The shim layer 20 then formulates the individual calls to the API of the SNMP agent 18 to carry out the request. This enables the network management station 12 to issue what amounts to a macro instruction and to have the shim layer 29 decompose that macro instruction into its elementary parts.

The metadata in the auxiliary MIB 22 is prespecified by a network administrator. The network administrator provides the metadata to the auxiliary MIB 22 through an SNMP session with the managed node 14a or by using the CLI (command line interface) of the managed node 14a. Alternatively, the network administrator can provide the metadata to the auxiliary MIB 22 remotely through a COPS-PR protocol session that uses a client type different from the client type used for other COPS-PR traffic between the management station 12 and the managed node 14a. On the basis of this client type, the shim layer 20 distinguishes between COPS-PR communications for accessing the auxiliary MIB 22 and COPS-PR communications for accessing the local MIB 16. Once the auxiliary MIB 22 has been built, the shim layer 20 can then begin operation.

The auxiliary MIB 22 can also include a listing of objects in the local MIB 16 whose values are to be reported periodically to the management station 12 for accounting purposes. In this embodiment, the shim layer 20 monitors the elapsed time since the last report to the management station 12. When the shim layer 20 determines that another accounting report is due, it formulates calls to the API of the SNMP agent 18 to retrieve the desired object values. It then packages those values in a COPS-PR message and sends that message to the management station 12.

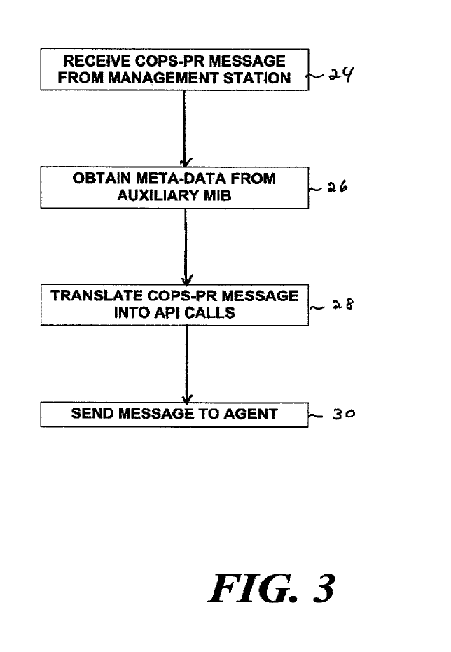

FIG. 3 shows the response of the shim layer to a COPS-PR communication received from the network manager. The shim layer receives 24 the COPS-PR message and obtains 26 metadata from the auxiliary MIB. This metadata enables the shim layer to identify the objects in the MIB that are to be accessed in connection with the COPS-PR message. The shim layer then formulates 28 a sequence of one or more calls to the API of the SNMP agent. Collectively, these API calls carry out the instructions in the received COPS-PR message.

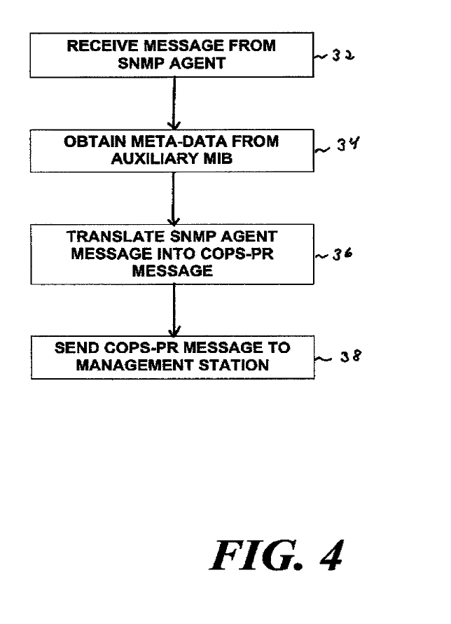

FIG. 4 summarizes the response of the shim layer to messages received from the SNMP agent. The shim layer receives 32 messages from the SNMP agent and accesses the auxiliary MIB to obtain 34 metadata. This metadata enables the shim layer to formulate 36 a COPS-PR message corresponding to the SNMP agent's messages. The shim layer then sends 38 this COPS-PR message to the network manager.

Other implementations are within the scope of the following claims:

What is claimed is:

1. A managed node comprising:
a first database having metadata descriptive of data stored in a second database;
a first process in communication with said second database; and
a second process in communication with said first process through a selected interface, said second process providing communication over a network through a selected protocol and having access to said metadata in said first database for translation between said selected interface and said selected protocol.

2. The managed node of claim 1, wherein said first process comprises an SNMP agent.

3. The managed node of claim 1, wherein said second process comprises a network shim layer providing an interface between said first process and said network.

4. The managed node of claim 3, wherein said said selected protocol for communication on said network comprises COPS-PR.

5. The managed node of claim 1, wherein said second database comprises a MIB.

6. The managed node of claim 5, wherein said selected interface comprises an application program interface of said SNMP agent.

7. The managed node of claim 5, wherein said second protocol comprises a COPS protocol.

8. The managed node of claim 1, wherein said metadata is obtained from a remote source.

9. A managed network comprising:
a management station; and
a managed node in communication with said management station using a selected protocol, said managed node including
a first database having metadata descriptive of data stored in a second database;
a first process in communication with a second process through a selected interface, said second process being in communication with said second database, said first process providing communication to said management station through said selected protocol and having access to said first database for translation between said selected protocol and said selected interface.

10. The managed network of claim 9, wherein said selected protocol for communication between said managed node and said management station comprises COPS-PR.

11. The managed network of claim 9, wherein said selected interface for communication between said first and second processes comprises an application program interface communication.

12. The managed network of claim 9, wherein said first process comprises an SNMP agent.

13. The managed network of claim 9, wherein said second process comprises a network shim layer providing an interface between said first process and a network.

14. The managed network of claim 13, wherein said selected protocol for communication between said network shim layer and said management station comprises COPS-PR.

15. The managed network of claim 9, wherein said second database comprises a MIB.

16. The managed network of claim 15, wherein said selected interface comprises an application program interface of said SNMP agent first.

17. The managed network of claim 15, wherein said protocol comprises a COPS protocol.

18. The managed network of claim 9, wherein said metadata is obtained from a remote source.

19. A method comprising:
receiving a first communication;
obtaining metadata from a first database to identify selected data in a second database, said selected data being dependent on said first communication;
on the basis of said metadata, translating said first communication into a second communication; and
relaying said second communication.

20. The method of claim 19, wherein
receiving a first communication comprises receiving a COPS-PR communication, and
relaying said second communication comprises relaying said second communication to an SNMP agent.

21. The method of claim 19, wherein
receiving a first communication comprises receiving a first communication from an SNMP agent, and
relaying said second communication comprises relaying said second communication to a management station.

22. The method of claim 19, wherein translating said first communication comprises accessing selected data from a MIB.

23. The method of claim 22, wherein accessing selected data comprises selecting said data on the basis of metadata from said first database.

24. A computer-readable medium having software encoded thereon, said software comprising instructions for:
receiving a first communication;
obtaining metadata from a first database to identify selected data in a second database, said selected data being dependent on said first communication;
on the basis of said metadata, translating said first communication into a second communication; and
relaying said second communication.

25. The computer-readable medium of claim 24, wherein
said instructions for receiving a first communication comprise instructions for receiving a COPS-PR communication, and
said instructions for relaying said second communication comprise instructions for relaying said second communication to an SNMP agent.

26. The computer-readable medium of claim 24, wherein
said instructions for receiving a first communication comprise instructions for receiving a first communication from an SNMP agent, and
said instructions for relaying said second communication comprise instructions for relaying said second communication to a management station.

27. The computer-readable medium of claim 24, wherein said instructions for translating said first communication comprise instructions for accessing selected data from a MIB.

28. The computer-readable medium of claim 27, wherein said instructions for accessing selected data comprise instructions for selecting said data on the basis of metadata from said first database.

29. An apparatus comprising:
in a managed network node,
stored descriptive information that describes other, network management information stored in said managed network node, and
stored instructions that use said stored descriptive information to aid a network management station in accessing said network management information.

30. The apparatus of claim 29, wherein said stored instructions are configured to communicate with said network management station using a COPS protocol and to access said network management information using an application program interface SNMP.

31. A method comprising:
enabling communication of network management information between a first process and a remote network management facility in accordance with a communication protocol, and
enabling communication of said network management information between said first process and a local network management facility in accordance with an interface second.

32. The method of claim 31, further comprising:
selecting said first communication protocol to be a COPS protocol; and
selecting said interface to be an application program interface of an SNMP agent.second communication protocol to be SNMP.

33. A process comprising instructions for:
enabling communication of network management information between a first process and a remote network management facility in accordance with a communication protocol, and
enabling communication of said network management information between said first process and a local network management facility in accordance an interface.

34. The process of claim 33, further comprising
instructions for communicating with said remote network management facility using a COPS protocol; and
instructions for communicating with said local network management facility using an application program interface of an SNMP agent SNMP.
